(19) United States
(12) Patent Application Publication
(10) Pub. No.: US 2023/0408026 A1
(43) Pub. Date: Dec. 21, 2023

(54) C-Shaped Stocking Holder clamp

(71) Applicant: Jeffery J. Kacines, Allen, TX (US)

(72) Inventor: Jeffery J. Kacines, Allen, TX (US)

(21) Appl. No.: 18/206,167

(22) Filed: Jun. 6, 2023

Related U.S. Application Data
(60) Provisional application No. 63/352,335, filed on Jun. 15, 2022.

(51) Int. Cl. F16M 13/02

(52) U.S. Cl. CPC F16M 13/02

(57) ABSTRACT

A hanger that has a C-shaped body and two ends capped with ball-like structures. The hanger is constructed of a resilient material so that when the ends are forced apart, a spacing therebetween increases, and when released, the ends move together. In use, the C-shaped hanger is spread apart and applied to a ceiling beam, and is then released so that the ball ends firmly clamp to the opposing sides of the beam. Items can be suspended from the body of the C-shaped hanger and displayed at an elevated position for all in the vicinity to view the item.

### TECHNICAL FIELD OF THE INVENTION

The present invention relates in general to decoration holders and more particularly to stocking holders for hanging stockings from overhead beams and the like.

### BACKGROUND OF THE INVENTION

C-shaped bracelets, known as cuff bracelets, are a popular type of jewelry. The cuff-type bracelets are fabricated with many different designs to provide many different styles of jewelry to satisfy the wants of purchasers. The bracelets are available with many different styles in the body part of the bracelet, as well as the end shapes of the C-shaped bracelet body. The shapes of the bracelet C-shaped body included spiral strands, rippled, jeweled, etc. The ends of the C-shaped bracelet body can be ball shaped, oval and many other shapes. Further, the cuff bracelets come in many different colors and materials to provide fanciful eye-catching features.

The cuff type bracelets are worn by either slipping one's hand through the large central circular opening of the bracelet, or the ends of the C-shaped body are spread apart and slipped over the wrist of the user. Once the user wears the cuff bracelet, it loosely hangs onto the user's wrist, it is susceptible to movement, and the ends remain spaced apart without gripping the user's wrist.

The invention disclosed herein discloses a new use for cuff-type bracelets. As set forth below, the invention utilizes the shape of a cuff bracelet as a hanger for clamping to opposite sides of an anchor structure. The ends of the C-shaped hanger are spread apart and applied to a beam, or the like, and then released so that the hanger is clamped to the beam. The body part of the hanger is available for suspending one or more items therefrom so that such items are displayed at an elevated location.

### SUMMARY OF THE INVENTION

In accordance with the principles and concepts of the invention, disclosed is a hanger that can be clamped to the opposing sides of a beam, irrespective of the orientation of the beam. When the hangers are attached to a horizontal ceiling beam, many decorative items can be displayed at an elevated location for easy observance by persons.

According to a feature of the invention, the hanger is C-shaped and is resilient or spring-like so that the ends can be spread apart and placed on opposite sides of the beam. When released, the ends of the C-shaped hanger come together and are thus clamped to the beam. Items can be suspended from the C-shaped hanger and displayed. If the items are equipped with an open hook, the hook can simply be hooked over the midsection of the hanger so that the item is suspended therefrom. If the item is constructed with a closed loop, the end of the C-shaped hanger can be threaded through the loop and the hanger is then attached to a beam.

According to a feature of the C-shaped hanger, the body thereof is constructed with spiral wound wires around a hollow core, and formed into the C-shape. The body of the C-shaped hanger is coated with a decorative covering. The ends of the C-shaped hanger are covered with respective caps that engage the sidewalls of a beam when attached thereto. In one embodiment, the caps are spherical caps with holes therein to receive the respective ends of the C-shaped hanger body.

With regard to a feature of the invention, the end caps are covered with a soft plastic or other friction material so that when the C-shaped hanger is attached to a beam, with the weight of the decorative item thereon, the hanger does not inadvertently slide off the beam. The end caps can be constructed with other shapes to address the particular needs required.

According to one embodiment of the invention, disclosed is a method of using a resilient C-shaped hanger for suspending an item therefrom. The method comprising forcing opposing ends of the resilient C-shaped hanger apart so that a size of an opening between the opposing ends is increased sufficiently to place the opposing ends of the C-shaped hanger around an edge of a beam. The resilient C-shaped hanger is released so that a distance between the opposing ends decreases in size and the C-shaped hanger is clamped to opposite sides of the beam. The item is then suspended from the resilient C-shaped hanger so that the item is displayed at an elevated position on the beam.

According to another embodiment of the invention, disclosed is a method of using a resilient C-shaped hanger for suspending an item therefrom, including locating a horizontal beam with opposing vertical sidewalls and a bottom. The opposing ends of the resilient C-shaped hanger are forced apart so that a spacing between the opposing ends is increased sufficiently to engage each end of the C-shaped hanger with a respective vertical side of the horizontal beam. The resilient C-shaped hanger is released so that the spacing between the opposing ends decreases in size and the opposing ends are clamped to the sidewalls of the beam. A midsection of the C-shaped hanger is allowed to be located below the bottom of the horizontal beam. The item is then suspended from the midsection of the resilient C-shaped hanger so that the item is displayed below the horizontal beam.

### BRIEF DESCRIPTION OF THE DRAWINGS

Further features and advantages will become apparent from the following and more particular description of the preferred and other embodiments of the invention, as illustrated in the accompanying drawings in which like reference characters generally refer to the same parts, functions or elements throughout the views, and in which:

FIG. 1 is a side view of the C-shaped hanger constructed according to an embodiment of the invention;

FIG. 2 is an isometric enlarged cross-sectional view of an end of the tubular stock from which the hanger is formed;

FIG. 3 is an end view of the tubular stock of FIG. 2, with the individual strands spread apart to illustrate the construction of the tubular stock material;

FIG. 4 is a side view of the C-shaped hanger of FIG. 1, but with the ball ends spread apart;

FIG. 5 is an isometric view of the C-shaped hanger being manually spread apart and clamped to an overhead beam; and

FIG. 6 is an isometric view of the C-shaped hanger applied to an overhead beam, with a Christmas stocking suspended therefrom.

### DETAILED DESCRIPTION OF THE INVENTION

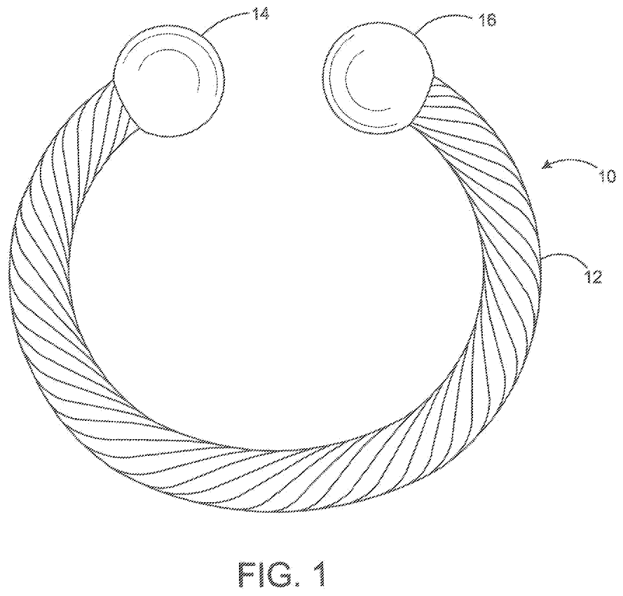

FIG. 1 illustrates the C-shaped article of the invention, in its relaxed state, that is adapted for hanging stockings from a beam or the like. The article comprises a hanger 10 that has a resilient C-shaped body 12 with knob-like end caps 14 and 16. The knob-like ends 14 and 16 are shaped like balls that are attached to the respective ends of the C-shaped hanger body 12. The term “C-shaped” as used herein generally means a device that has two ends that are connected with a body that includes a curve. As will be described in more detail below, the hanger body 12 is constructed with a spring-like material so that the knob-like ends 14 and 16 can be manually spread apart and placed on opposite sides of a beam, and then released so that the knob-like ends 14 and 16 relax and become clamped to the beam. Decorative items can then be suspended from the hanger body 12 and displayed.

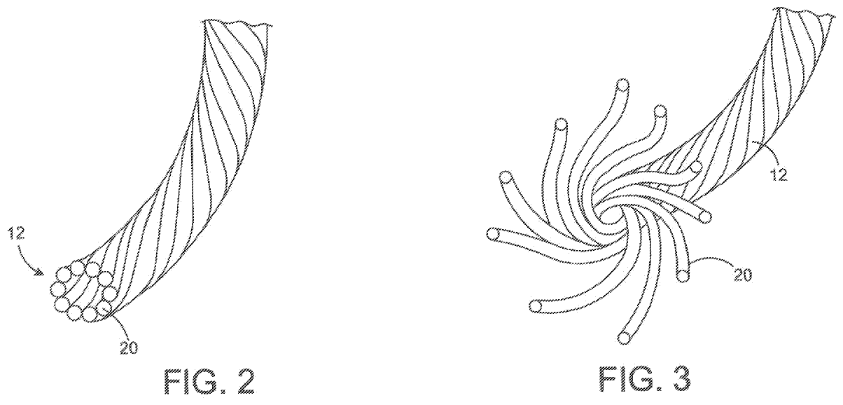

In the preferred embodiment, the hanger body 12 is constructed from a stock of linear tubular metallic material, having spiral strands of material cross-sectionally formed in a circle, as illustrated in FIG. 2. The stock linear material is made of a resilient or spring-like metal so that when manually distorted, it will return to its general original state or shape. The stock material is preferably a copper or copper alloy type of metal. Many other resilient materials, including synthetics, can be employed. Moreover, for purposes of decoration, the metallic material is shaped and appears as a tubular rope with visible spiral strands. Otherwise, the hanger body 12 can be constructed with other decorative shapes, or just a natural circular rod, without exterior decorative designs.

FIG. 2 illustrates the cut end of the stock material from which the hanger body 12 is fabricated. In one embodiment, the stock tubular material has individual spiral strands 20 like a hollow rope, and is conventionally available. FIG. 3 illustrates the individual spiral strands 20 that are separated for purposes of clarity to illustrate the construction of the stock material. The linear stock of metallic tubular material is cut to individual lengths so that each length is that desired to form the hanger body 12. The individual lengths of the stock material are then bent or otherwise formed into a circular, oval or oblong shape, with a portion of the circle missing, as illustrated in FIG. 1. A C-shape hanger body 12 is thus formed. The resilient stock material can be cut with a saw or other conventional metal stamping cutter.

In the preferred embodiment, the radius of the circular C-shaped hanger body is about 73.3 mm. The spacing between the ball ends 14 and 16 of the hanger 10 when relaxed is about 16.25 mm, and can be spread apart to an opening of about 76.2 mm. The hanger body 12 can be squeezed together so that the opening is only about 14.8 mm. The hanger body 12 of FIG. 2 is about 8 mm in diameter. As noted above, the outer overall diameter, or width, of the C-shaped hanger body 12 is about 73.3 mm. With this specific construction, the hanger 10 is well adapted for clamping to a beam having a width of about 76.2 mm. It can be appreciated that hangers 10 can be fabricated with dimensions suitable for clamping to many other sizes of beams.

After the C-shaped hanger body 12 is formed, the exposed hanger ends are covered by the steel knob-like ends 14 and 16. The steel balls 14 and 16 can be about 14 mm in diameter. The ball-shaped ends 14 and 16 have respective holes formed therein for insertion of the respective cut ends of the hanger body 12. The ball-shaped ends 14 and 16 can be friction clamped to the respective hanger body ends, welded, or otherwise adhered, etc. In other words, the ball-shaped ends 14 and 16 are suitably fixed in whatever manner to the ends of the C-shaped hanger body 12. Those skilled in the art can appreciate that the ends of the hanger body 12 can capped with structures other than spherical balls 14 and 16. For example, the ends of the hanger body 12 can be capped with planar structures to increase the surface contact area to the beam 30. Other shapes of the end structures can be employed to achieve the particular results desired.

Once the hanger 10 is fabricated in the manner set forth above, it can be coated so as to preserve its appearance. The hanger 10 is preferably plated, painted or powder coated to provide a surface coating that resists corrosion or discoloring. A plastic coating is also suitable for use. Other coatings are possible and can be readily accomplished by those skilled in the art.

While not shown, the ball ends 14 and 16 can be equipped with individual spherical silicon sleeves, or other types of a soft plastic material, such as a transparent plastic spheres to prevent the inadvertent dislocation of the hanger 10 once clamped to the overhead beam. Instead of employing a silicon spherical sleeve, the ball ends 14 and 16 can be coated with the soft plastic or rubber material. Other techniques can be employed to provide improved friction between the ball ends 14 and 16 and the overhead beam.

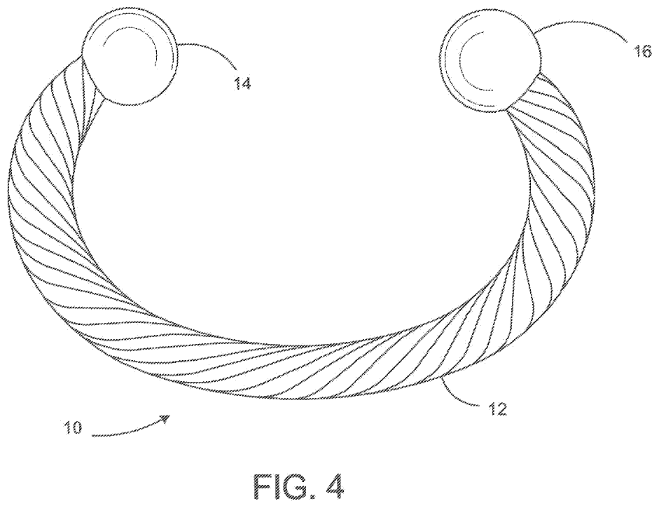

FIG. 4 illustrates the hanger 10 in its state in which the ball ends 14 and 16 are manually spread apart. It can be understood that the hanger 10, being resilient, will return somewhat to its relaxed state when the ball ends 14 and 16 are released or freed, but often not to the extent shown in FIG. 1. In practice, the ball ends 14 and 16 of the hanger 10 may spring back several millimeters. It can be understood that the hanger 10 can be manipulated so that the ball ends 14 and 16 are manually spread apart and placed on opposite sides of an anchor beam, or the like, and released so that the hanger 10 is firmly clamped to the anchor beam. With this arrangement, other items can be suspended from the hanger 10 for display thereof. Christmas stockings can be suspended from the hanger 10, Christmas ornaments, and many other items can be suspended from the hanger 10 when it is clamped to the anchor beam. It can be appreciated that since the hanger 10 is firmly clamped to an overhead anchor beam, it is elevated so as to be readily seen by those in the vicinity. Rather than using a copper or copper alloy as the material from which the hanger 10 is constructed, other materials can be employed so that there is a greater degree of spring action. As can be appreciated, the heavier the item to be suspended from the hanger 10, more spring force may be needed to allow the hanger 10 to remain firmly clamped to the beam.

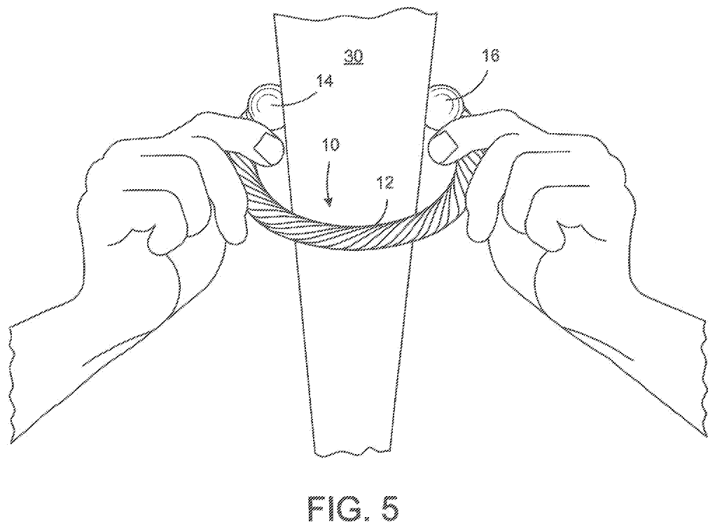

FIG. 5 illustrates the installation of the hanger 10 to an overhead beam 30. In the use of the hanger 10, opposite sides of the hanger 10 are grasped and manually spread apart. Preferably, the hanger 10 is spread apart somewhat more than the width of the beam 30 to which it is to be clamped. In this state, the resilient material of the hanger 10 is tensioned so that the tendency of the ball ends 14 and 16 is to be forcefully move together when released. Once the ends of the hanger 10 are sufficiently spread apart, it is raised to allow the beam 30 to be located between the ball ends 14 and 16. Then, the tensioned hanger 10 is released so that the ball ends 14 and 16 spring back together and are firmly clamped to opposite sides of the beam 30. Stated another way, in use, the hanger 10 remains under spring compression to the opposite sides of the overhead beam 30. Further, the hanger 10 remains stationary during use. It can be seen from FIG. 5 that the middle part of the hanger body 12 is spaced sufficiently from the bottom of the beam 30. This allows items to be suspended from the hanger 10 and displayed in an elevated position. Since the hanger 10 is elevated, the items suspended therefrom are easily seen by anyone in the vicinity. A Christmas stocking, for example, can be hung from the hanger 10 and openly displayed at the elevated position. As noted above, many other items can be suspended from the hanger 10, such as real or artificial mistletoe.

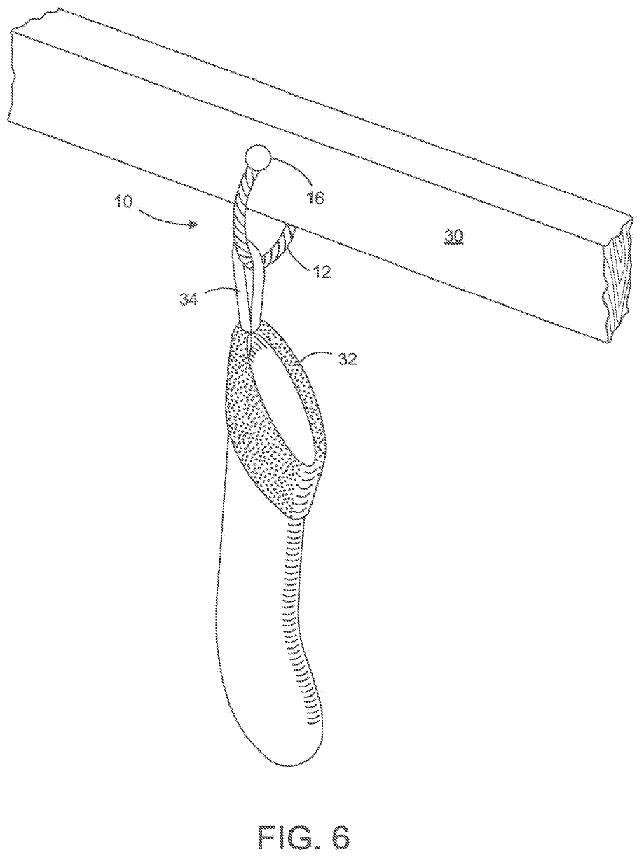

FIG. 6 illustrates the application of the C-shaped hanger 10 to an overhead beam 30, and an ornament 32 suspended therefrom. In the illustration, the ornament is a Christmas stocking 32. As described above, the C-shaped hanger 10 is spread apart and clamped to the overhead beam 30. Any ornament can then be suspended therefrom. In the instant case, a Christmas stocking 32 is equipped with a loop 34 attached to the upper part of the stocking 32. The hook 34 is simply inserted around one end of the C-shaped hanger and located at the lower curved part of the C-shaped hanger 10. The Christmas stocking 32 is thus suspended for display under the beam 30. The removal of the Christmas stocking 32 is the reverse operation described above. As can be appreciated, more than one ornament can be suspended at the same time from the C-shaped hanger 10.

When the C-shaped hanger is used specifically with rough surface wood beams and the like, the ball ends 14 and 16 can be replaced with pointed ends that can be embedded in the wood. With this arrangement, the C-shaped hanger can support heavier ornaments.

In order to change out the item suspended from the hanger 10, or move the hanger 10 to another position on the overhead beam 30, one simply needs to grasp the opposite ends of the hanger body 12, pull them apart to release the ball ends 14 and 16 from their clamped positions to the beam 30, and lower the hanger 10. The hanger 10 is thus released from the beam 30 and can be moved to another position on the beam 30, or to another beam 30.

Items can be suspended from the hanger 10 is at least two different manners. First, the item can be attached to an open loop, much like the hook of a clothes hanger, so that the hook is inserted onto the hanger body 12 of the hanger 10. In other words, the hanger 10 is first clamped to the beam in the manner described above, and then the hook attached to the item is inserted onto the hanger body 12. With this technique, the item can be removed from the hanger 10 without removing the hanger 10 from the beam 30. The other technique for suspending an item from the hanger 10 is to attach a closed loop to the item, and then insert one ball end 14 or 16 through the closed loop so as to loosely attach the item to the hanger 10. Then, the hanger 10 is spread apart and lifted with the item toward the beam 30 and clamped to the beam 30. With this technique, the item cannot be removed from the hanger 10 without removing the hanger 10 from the beam 30.

The hanger 10 can also be constructed so that a hook or loop is integrated into the hanger 10 itself. For example, one or more strands 20 of the hanger body can be separated from the body and prevented from being inserted into one or both of the ball ends 14 and 16. The separated strand(s) can be shaped as a hook or loop so that items can be suspended therefrom. A hook or loop can also be fastened to the hanger body at its lowest point for hanging items therefrom. Such a hook or loop can be fixed to the hanger body by an adhesive or other suitable means. Still further, a hook or loop, or multiple hooks or loops, can be constructed with a circular part into which the hanger body is inserted before the end caps are installed. With this arrangement, the hook or loop apparatus can be moved along the body of the hanger 10.

The preferred embodiment described above is constructed for attachment to an overhead beam, but the hanger 10 can be attached or clamped to many other anchor structures, even vertical beams or wall ends. Many homes employ a short wall that extends from the ceiling a short distance for dividing one room from another. The hanger 10 of the invention can be clamped to such wall structures. Further, the hanger 10 can be clamped to the lower part of a ceiling fan, to a ceiling light fixture, and many other fixtures and structures. As noted above, the invention is not limited to attachment to a horizontal beam, but can also be attached to opposing sides of a vertical wall or beam edge. A plurality of C-shaped hangers can be attached vertically to a vertical beam so that the edge of the wall or beam can be decorated with many decorative items.

While the preferred and other embodiments of the invention have been disclosed with reference to a specific hanger, and associated methods of fabrication thereof, it is to be understood that many changes in detail may be made as a matter of engineering or design choices without departing from the spirit and scope of the invention, as defined by the appended claims.

What is claimed is:

1. A method of using a resilient C-shaped hanger for suspending an item therefrom, the method comprising:
forcing opposing ends of the resilient C-shaped hanger apart so that a size of an opening between said opposing ends is increased sufficiently to place the opposing ends of said C-shaped hanger around an edge of a beam;
releasing the resilient C-shaped hanger so that a distance between the opposing ends decreases in size and said C-shaped hanger is clamped to opposite sides of the beam; and
suspending the item from the resilient C-shaped hanger so that the item is displayed at an elevated position on said beam.

2. The method of claim 1, wherein said resilient C-shaped hanger has a pair of ends that remain clamped to respective sides of said beam during use.

3. The method of claim 1, wherein said resilient C-shaped hanger remains stationary during use.

4. The method of claim 2, further including using a soft pliable material on the pair of ends to increase a frictional contact with the beam.

5. The method of claim 2, further including attaching a ball-shaped device to each end of the resilient C-shaped hanger.

6. The method of claim 1, further including fabricating a body of the resilient C-shaped hanger using spiral strands of a resilient material.

7. The method of claim 6, further including using the spiral strands that spiral around a hollow central portion of the hanger body.

8. The method of claim 1, further including attaching said C-shaped hanger to a horizontal beam suspended above a floor so that the ornament is elevated above the floor.

9. The method of claim 8, further including attaching said C-shaped hanger to said horizontal beam so that said C-shaped hanger has a midsection located between said opposing ends, where said midsection is located below said horizontal beam.

10. The method of claim 1, further including hooking a hook attached to the item over the midsection of said C-shaped hanger.

11. The method of claim 1, further including selecting a Christmas stocking as the item.

12. The method of claim 1, further including fabricating said C-shaped hanger prior to the using of said C-shaped hanger, said fabricating including cutting a length of a stock resilient metal rope having spiral metal strands, bending the length of the metal rope to a desired shape, and attaching respective end caps to the cut ends of the length of the metal rope.

13. A method of using a resilient C-shaped hanger for suspending an item therefrom, the method comprising:
locating a horizontal beam with opposing vertical sidewalls and a bottom;
forcing opposing ends of the resilient C-shaped hanger apart so that a spacing between said opposing ends is increased sufficiently to engage each end of said C-shaped hanger with a respective said vertical side of said horizontal beam;
releasing said resilient C-shaped hanger so that the spacing between the opposing ends decreases in size and said opposing ends are clamped to the sidewalls of said beam;
allowing a midsection of said C-shaped hanger to be located below the bottom of said horizontal beam; and
suspending the item from the midsection of said resilient C-shaped hanger so that the item is displayed below said horizontal beam.

14. The method of claim 13, further including using said C-shaped hanger with an endcap attached to the respective ends of said C-shaped hanger, and using endcaps that are larger in diameter with respect to a diameter of a body of said C-shaped hanger.

15. The method of claim 14, further including using endcaps that are spherical shaped.

16. The method of claim 13, further including using said C-shaped hanger having a body formed with spiral strands so that said C-shaped hanger body resembles a rope.

17. The method of claim 13, further including hanging a decorative item from said C-shaped hanger by threading an end of said C-shaped hanger through a loop attached to said decorative item before said C-shaped hanger is attached to said beam.

18. The method of claim 13, further including hanging a decorative item from said C-shaped hanger by hooking an open loop attached to the decorative item to the body of said C-shaped hanger after said C-shaped hanger is attached to said beam.
